(19) United States
(12) Patent Application Publication
(10) Pub. No.: US 2011/0077138 A1
(43) Pub. Date: Mar. 31, 2011

(54) Apparatus and method for folding blank into a box

(75) Inventor: Joe Pagani, Clifton, NJ (US)

(73) Assignee: Accurate Box Company, Inc., Paterson, NJ (US)

(21) Appl. No.: 12/587,013

(22) Filed: Sep. 30, 2009

(51) Int. Cl. B31B 3/26

(52) U.S. Cl. 493/162

(57) ABSTRACT

An apparatus facilitates folding of a blank to form a box. When the blank is pressed into the apparatus, corner panels of the blank are initially folded by folding surfaces of the apparatus so that the corner panels are disposed inside side panel surfaces of the blank, which are folded by other folding surfaces of the apparatus. The apparatus further includes folding surfaces for folding the side and end panels of the blank into a vertical position. A base panel of the blank, and the side panels, end panels and the corner panels which are attached to the base panel, are received in an interior aperture of the apparatus during folding of the blank to form the box.

### FIELD OF THE INVENTION

The present invention relates to boxes, and more particularly, to method and apparatus for folding blanks to form boxes.

### BACKGROUND OF THE INVENTION

Boxes may be made from blanks by folding along fold lines included in the blanks. The blanks may be folded into boxes using an automated process, or manually.

Automated processes for folding blanks into boxes typically require the use of machines that are relatively costly and occupy relatively large amounts of space.

Folding of blanks into boxes manually typically is a laborious and time consuming process. For example, oftentimes several panels of a blank may need to be folded to obtain a box. In addition, the panels of the blank may need to be folded in a specific sequence to obtain the box.

There exists a need for a device that may facilitate quick, easy and inexpensive assembly of boxes by manual folding of blanks.

### SUMMARY OF THE INVENTION

In accordance with an aspect of the present invention, an apparatus may be used to facilitate folding of a blank into a box. The blank may include a base panel attached to opposing first and second side panels and opposing first and second end panels, first and second corner panels attached respectively to opposing edges of the first end panel, and third and fourth corner panels attached respectively to opposing edges of the second end panel. The apparatus may include a base having opposing first and second sides and opposing first and second ends. The apparatus further may include at least one first side panel folding means and at least one second side panel folding means arranged on the first side and the second side of the base, respectively. Each of the at least one first and second side panels means may include folding surfaces that extend upwardly and outwardly from the base for, respectively, engaging and folding the first side panel and the second side panel of the blank. In addition, a first end panel folding means may be arranged on the first end of the base and include a folding surface that extends upwardly and outwardly from the base for engaging and folding the first end panel, and a second end panel folding means may be arranged on the second end of the base and include a folding surface that extends upwardly and outwardly from the base for engaging and folding the second end panel. The at least one second end panel folding means may include a first positioning means for positioning the second end panel prior to folding of the blank. The apparatus also may include first and second corner panel folding means arranged opposite each other on the first and second sides of the base. Each of the first and second corner panel folding means may include a folding surface that extends upwardly and outwardly from the base for engaging and folding, respectively, the first corner panel and the second corner panel of the blank. In addition, each of the first and second corner panel folding means may include a second positioning means for positioning, respectively, the first corner panel and the second corner panel prior to folding of the blank. In addition, the apparatus may include third and fourth corner panel folding means arranged opposite each other on the first and second sides of the base. Each of the third and fourth corner panel folding means may include a folding surface that extends upwardly and outwardly from the base for engaging and folding, respectively, the third corner panel and the fourth corner panel of the blank. The first, second, third and fourth corner panel folding means and the first and second side panel folding means may be adapted such that, when the blank is in an unfolded condition on the apparatus with the first and second corner panels positioned by the first positioning means and the third and fourth corner panels positioned by the second positioning means, and when the blank is pressed in the direction of the base, the first, second, third and fourth corner panels are folded upwardly by the folding surfaces of the respective first, second, third and fourth corner panel folding means so the first and third corner panels overlie inwardly facing surface of the first side panel and the second and fourth corner panels overlie inwardly facing surface of the second side panel as the first and second side panels are folded inwardly by the folding surfaces of the respectively first and second side panel folding means.

In accordance with another aspect of the invention, a method is provided for folding a blank into a box. The blank includes a base panel attached to opposing first and second side panels and opposing first and second end panels, first and second corner panels attached respectively to opposing edges of the first end panel, and third and fourth corner panels attached respectively to opposing edges of the second end panel. The method includes positioning the blank horizontally over an apparatus having a plurality of folding surfaces; and pressing the blank downwardly into the apparatus to engage the folding surfaces, such that the first, second, third and fourth corner panels are folded upwardly, and the first and third corner panels are positioned inside the first side panel and the second and fourth corner panels are positioned inside the second side panel as the first and second side panels and the first and second end panels are folded inwardly toward the base.

In a further aspect of the invention, an apparatus may be used for folding a blank into a box. The blank may include a base panel attached to opposing first and second side panels and opposing first and second end panels, first and second corner panels attached respectively to opposing edges of the first end panel, and third and fourth corner panels attached respectively to opposing edges of the second end panel. The apparatus includes a base; positioning means extending from the base for positioning the blank over the base in a predetermined position; side panel folding means disposed on opposite sides of the base and including folding surfaces that extend upwardly and outwardly from the base; end panel folding means disposed at opposite ends of said base and including folding surfaces that extend upwardly and outwardly from the base; and corner panel folding means disposed on opposite sides of the base and including folding surfaces that have a greater incline than the incline of the folding surfaces of the side panel folding means, such that, when the blank is positioned over the base of the apparatus by the positioning means and pressed in the direction of the base, the first, second, third and fourth corner panels are folded upwardly to a first extent before the side panels are folded to the first extent.

### BRIEF DESCRIPTION OF THE DRAWINGS

Other objects and advantages of the present invention will be apparent from the following detailed description of the present preferred embodiments, which description should be considered in conjunction with the accompanying drawings in which like reference indicate similar elements and in which:

FIG. 1 is a plan view of an exemplary blank, in accordance with an aspect of the invention, from which the box of FIG. 8 is constructed.

FIG. 2 is a perspective view of an exemplary jig for use in construction of a box using the blank of FIG. 1, in accordance with an aspect of the present invention.

FIG. 3 is a perspective view of the blank of FIG. 1 juxtaposed with respect to the jig of FIG. 2.

FIG. 4 is a perspective view of the blank of FIG. 1 engaged by the jig of FIG. 2, prior to folding of the blank.

FIG. 4A is a cross-sectional view of a portion of the blank and jig as shown in FIG. 4 at cross-sectional line 4A-4A.

FIG. 4B is a cross-sectional view of a portion of the blank and jig as shown in FIG. 4 at cross-sectional line 4B-4B.

FIG. 5 is a perspective view of the blank and jig combination, with the blank engaged by the jig and being in a partially folded condition.

FIG. 6 is another perspective view of the blank and jig combination, with the blank engaged by the jig and being in a partially folded condition.

FIG. 7 is a perspective view of the blank in a partially folded condition, as obtained by use of the jig of FIG. 2.

FIG. 8 is a perspective view of a box constructed from the blank of FIG. 1.

### DETAILED DESCRIPTION

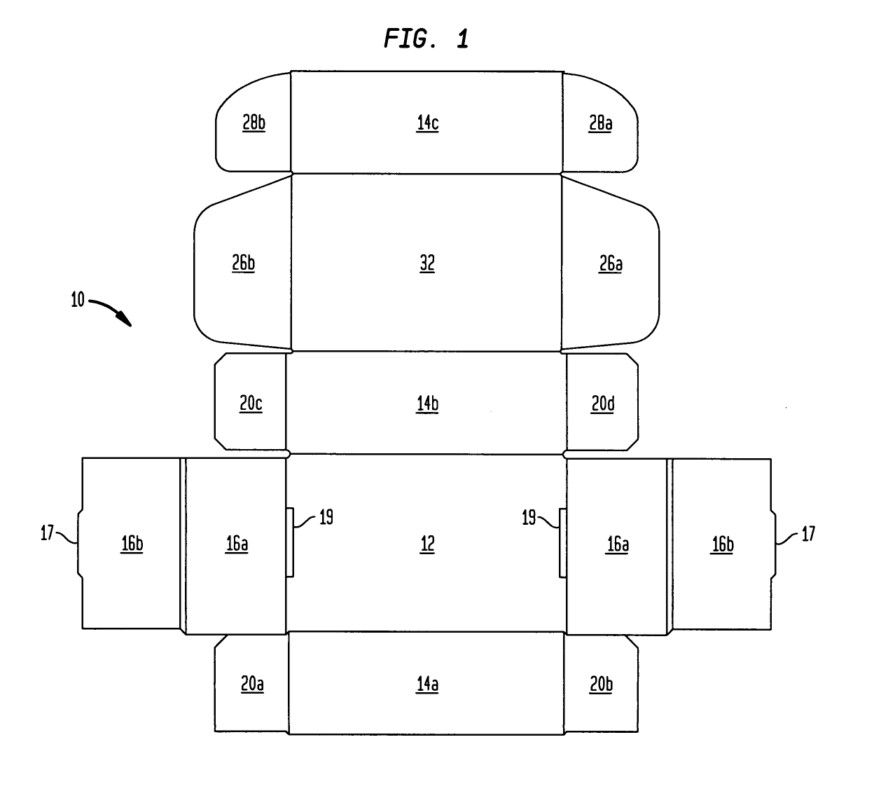

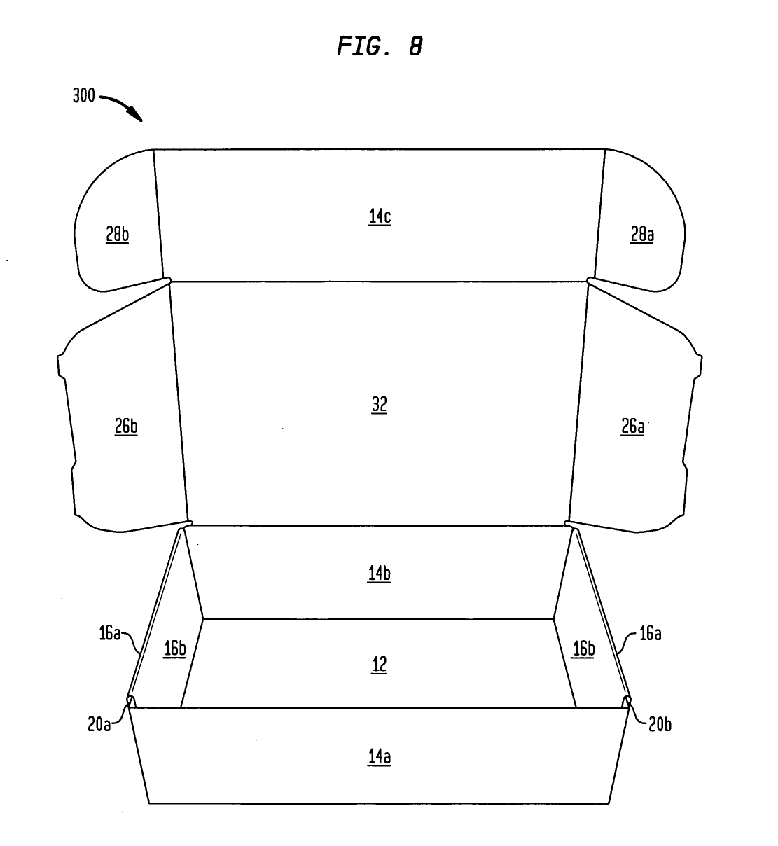

A container 300, in an assembled condition as shown in FIG. 8, may be formed by folding an exemplary blank 10, which is shown in FIG. 1 in an unfolded position. The blank 10, which may be made from corrugated or paperboard material, has a substantially uniform thickness and includes fold lines that define a plurality of panels. The fold lines correspond to scored portions of the blank 10.

Referring to FIGS. 1 and 8, in accordance with an aspect of the present invention, the blank 10 includes a rectangular base or bottom panel 12. Two rectangular end panels 14a, 14b are attached to longer edges of the bottom panel 12, and two side panel members are attached to shorter edges of the bottom panel 12. Each of the side panel members includes an outer side panel 16a attached directly to the bottom panel 12 and an inner side panel 16b attached to the outer panel 16a. The longer edge of the panel 16b opposite the panel 16a includes a tab 17. In addition, the panel 12 defines an aperture 19 adjacent each of its shorter edges. The apertures 19 have substantially the same dimensions as, and are aligned with, the tabs 17 of the respective adjacent side panels 16b.

The blank 10 further includes corner panels 20a, 20b attached, respectively, to the shorter edges of the panel 14a. In addition, the blank 10 includes corner panels 20c, 20d attached, respectively, to the shorter edges of the panel 14b.

In addition, the blank 10 includes a rectangular cover or top panel 32 having lengthwise and widthwise dimensions that are slightly less than those of the bottom panel 12. The top panel 32 is attached at its longer edges, respectively, to the end panel 14b and a rectangular end panel 14c, and is attached at its shorter edges, respectively, to side flap panels 26a and 26b. The flap panels 26a, 26b are trapezoidally shaped and have lengthwise and widthwise dimensions that are slightly less than the corresponding lengthwise and widthwise dimensions of the panels 16a, 16b. The end panel 14c has lengthwise and widthwise dimensions that are slightly less than the corresponding lengthwise and widthwise dimensions of the panel 14a. In addition, side flap panels 28a, 28b are attached, respectively, to the opposing shorter edges of the panel 14c.

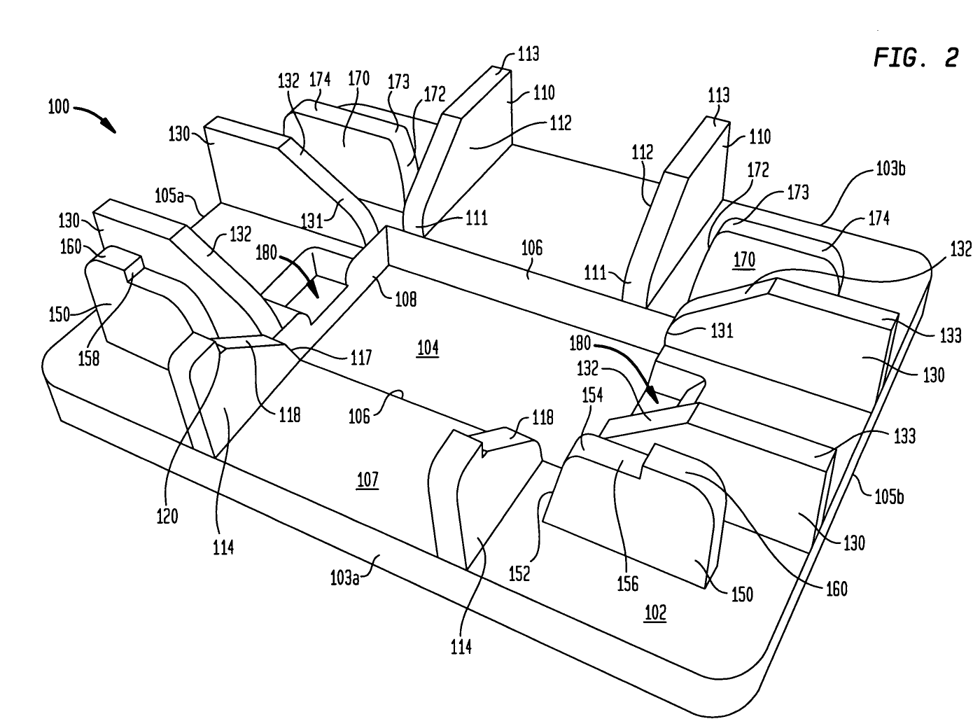

In accordance with an aspect of the present invention, a jig 100, as shown in FIG. 2, may be provided for assembling the container 300 from the blank 10. Referring to FIG. 2, in an exemplary embodiment of the jig 100, which may be made of wood or plastic material, includes a substantially rectangular base 102 having a flat top surface 107, and parallel exterior ends 103a, 103b that are longer than parallel exterior sides 105a, 105b. The base 102 further includes parallel interior end walls 106 and parallel interior side walls 108, which are parallel to the ends 103 and sides 105, respectively, and define a rectangular central aperture 104. The length of each of the end walls 106 is substantially equal to the longer dimension of the panel 12, and the length of each of the side walls 108 is substantially equal to the shorter dimension of the panel 12.

Along the end 103b of the base 102 are two upstanding end guides 110 that are parallel to the sides 105 of the base 102. In addition, along the end 103a of the base 102 are two upstanding end guides 114 that are parallel to the sides 105 of the base 102 and, respectively, oppose the two guides 110. The end guides 110 have inwardly facing edges 111 that extend vertically beginning at the top edge of the end wall 106 which is adjacent the end 103b, and desirably orthogonal to the surface 107. In addition, the end guides 110 include edges 112 that extend from the edges 111 and are inclined upwardly and extend outwardly with respect to the aperture 104. The end guides 110 further include top edges 113 that extend from the edges 112 and are substantially parallel to the surface 107 of the base 102. Similar to the guides 110, the guides 114 have inwardly facing edges 117 that extend vertically beginning at the top edge of the wall 106 which is adjacent the end 103a, and desirably orthogonal to the surface 107. Further, the guides 114 include edges 118 that extend from the edges 117 and are inclined upwardly and extend outwardly with respect to the aperture 104. The edges 111 and 112 of the guides 110 face the edges 117 and 118 of the opposing guides 114. In one embodiment, the edges 112, 118 are at about a forty-five degree angle with respect to the surface 107 of the base 102.

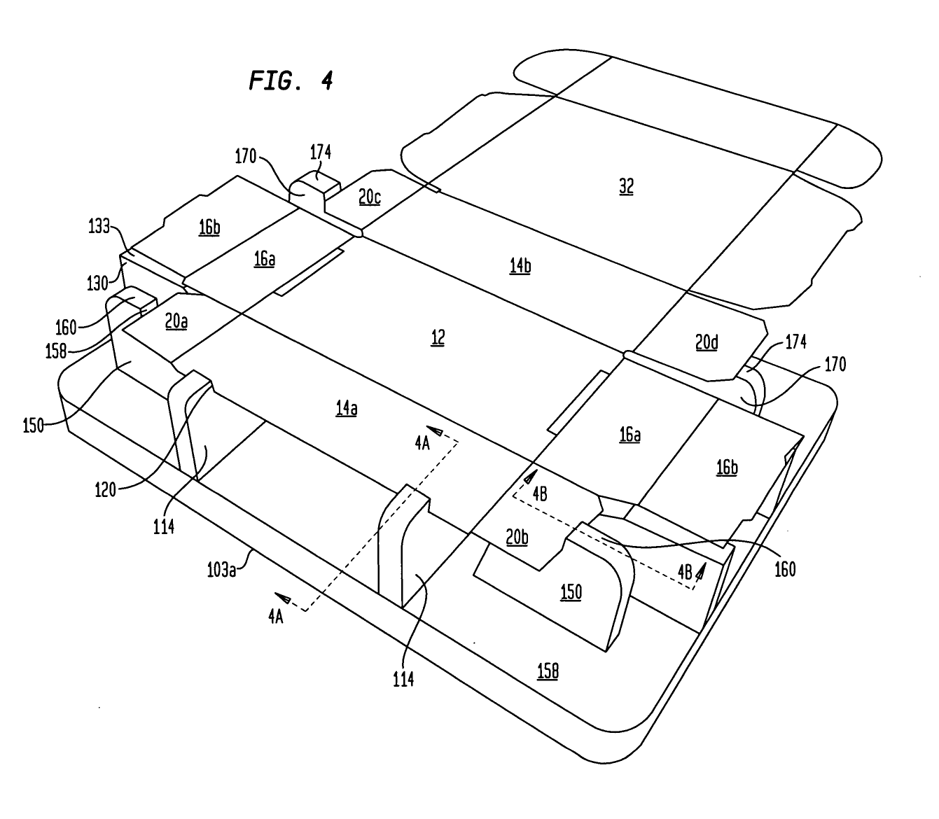

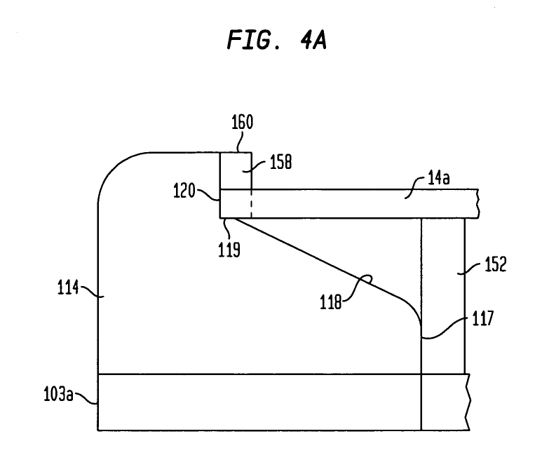

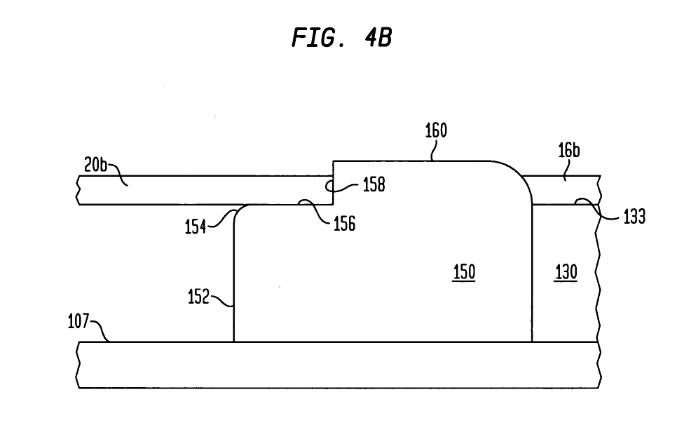

In addition, referring to FIGS. 4 and 4A, each of the edges 118, at an uppermost portion, terminates in a lip 119 that is parallel to the surface 107 of the base 102. Further, an edge extension 120 extends upwardly from, and desirably perpendicular to, the lip 119. The lips 119 are spaced the same distance from the surface 107 as the edges 113 of the guides 110. The lip 119 and the edge extension 120 of the guide 114, in combination, serve to position the blank 10, as discussed below. In addition, the edges 111, 112 of the guides 110, and the edges 117, 118 of the guides 114, form folding surfaces that may engage the blank 10, in the manner explained below.

Each of the sides 105 of the base 102 includes a pair of upstanding side guides 130 that are parallel to the ends 103 of the base 102. In a desired embodiment, the guides 130 on the side 105a are disposed to oppose the guides 130 on the side 105b. Each of the side guides 130 has an inwardly facing edge 131 that extends vertically from the top edge of the adjacent wall 108, and desirably is orthogonal to the surface 107. In addition, each of the side guides 130 includes an edge 132 that extends from the edge 131 and is inclined upwardly and outwardly with respect to the aperture 104. In one embodiment, the edges 132 are at about a forty-five degree angle with respect to the surface 107 of the base 102. The side guides 130 further include top edges 133 that extend from the edges 132, are parallel to the surface 107 of the base 102 and spaced the same distance from the surface 107 as the edges 113 of the guides 110. The edges 131, 132 of the guides 130 form folding surfaces that may engage the blank 10, in the manner explained below.

Further, a pair of upstanding corner guides 150 is disposed on the base 102 opposite to each other. One of the guides 150 is between the end 103a and the guide 130 which is adjacent to the end 103a and the side 105b, and between the side 105b and the guide 114 which is adjacent to the side 105b. The other of the guides 150 is between the end 103a and the guide 130 which is adjacent to the end 103a and the side 105a, and between the side 105a and the guide 114 which is adjacent to the side 105a. Further referring to FIG. 4B, each of the guides 150 includes an edge 152 extending from the surface 107 of the base 102, with a slight incline toward the adjacent side 105 of the base 102, to a rounded edge 154, which interconnects the edge 152 to an edge 156. In one embodiment, the edge 152 is substantially perpendicular to the surface 107, and the edge 156 is substantially parallel to the surface 107. In addition, each of the guides 150 includes an edge 158 extending upwardly from, and desirably perpendicular to, the edge 156, and an edge 160 extending from the edge 158. The edges 156 of the guides 150 are spaced the same distance from the surface 107 of the base 102 as the edges 113 of the guides 110. The edges 152, 154 of the guides 150 form folding surfaces that may engage the blank 10, in the manner explained below. In addition, the edges 156 and 158 of the guide 150, in combination, may serve to position the blank 10, as discussed below.

Further, the blank 10 includes a second pair of upstanding corner guides 170 disposed on the base 102 opposite to each other. One of the guides 170 is between the end 103b and the guide 130 which is adjacent to the end 103b and the side 105b, and between the side 105b and the guide 110 which is adjacent to the side 105b. The other of the guides 170 is between the end 103b and the guide 130 which is adjacent to the end 103b and the side 105a, and between the side 105a and the guide 110 which is adjacent to the side 105a. Each of the guides 170 includes an edge 172 extending upwardly from the surface 107, with a slight incline toward the adjacent side 105 of the base 102, to a rounded edge 173, which interconnects the edge 172 to an edge 174. In one embodiment, the edge 172 is substantially perpendicular to the surface 107. The edge 174 extends from the edge 172, is substantially parallel to the surface 107 of the base 102 and is spaced the same distance from the surface 107 as the edges 113 of the guides 110. The edges 172, 172 of the guides 170 form folding surfaces that may engage the blank 10, in the manner explained below.

Further, the base 102 includes a pair of opposing, rectangular cutouts 180, desirably extending only partially through the base 102. The cutouts 180 are disposed between the pairs of guides 130 on the respective sides 105, and are in communication with the aperture 104 at the walls 108, respectively.

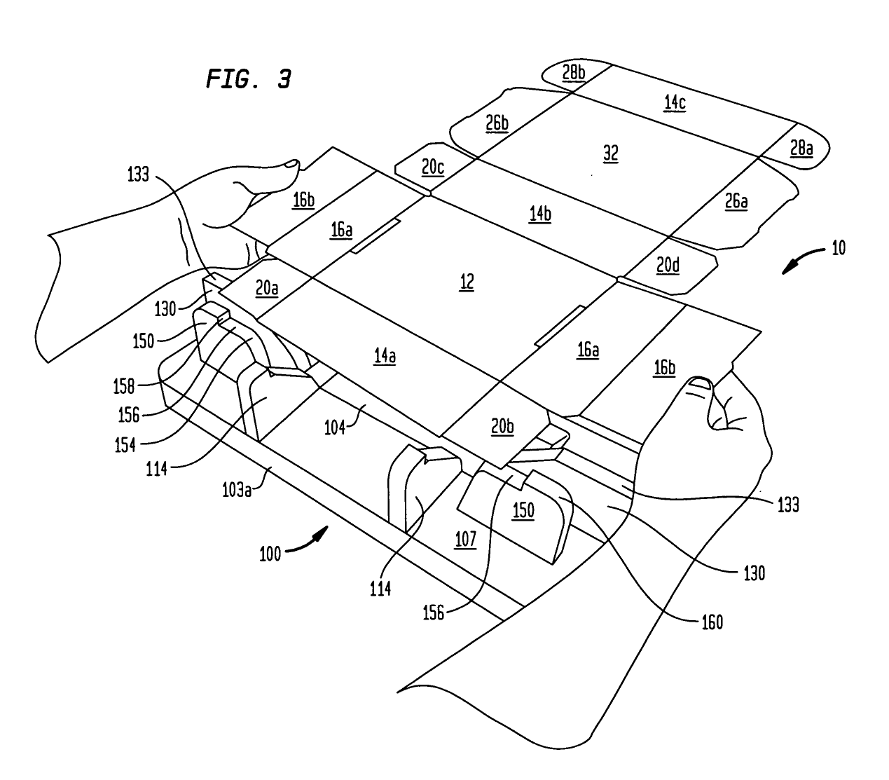

To assemble the blank 10 into a box, a user may position the blank 10 horizontally above the jig 100, as shown in FIGS. 3 and 4. Further referring to FIGS. 4A and 4B, the blank 10 may be initially positioned such that the corner panels 20a and 20b of the blank 10 rest on the surface of the edges 156 and contact the surfaces of the edges 158 of the opposing guides 150, respectively. In addition, the side panel 14a may rest on the surfaces of the lips 119 and contact the surfaces of the edges 120 of the guides 114. Further, the panels 16a, 16b may rest on the surfaces of the edges 133 of the guides 130, the panels 20c, 20d may rest on the surfaces of the edges 174 of the guides 170, and the panel 14b and the panel 32 may rest on the surfaces of the edges 113 of the guides 110. Consequently, in such position of the blank 10, the blank 10 rests on the jig 100 with the panel 12 superposed over the aperture 104.

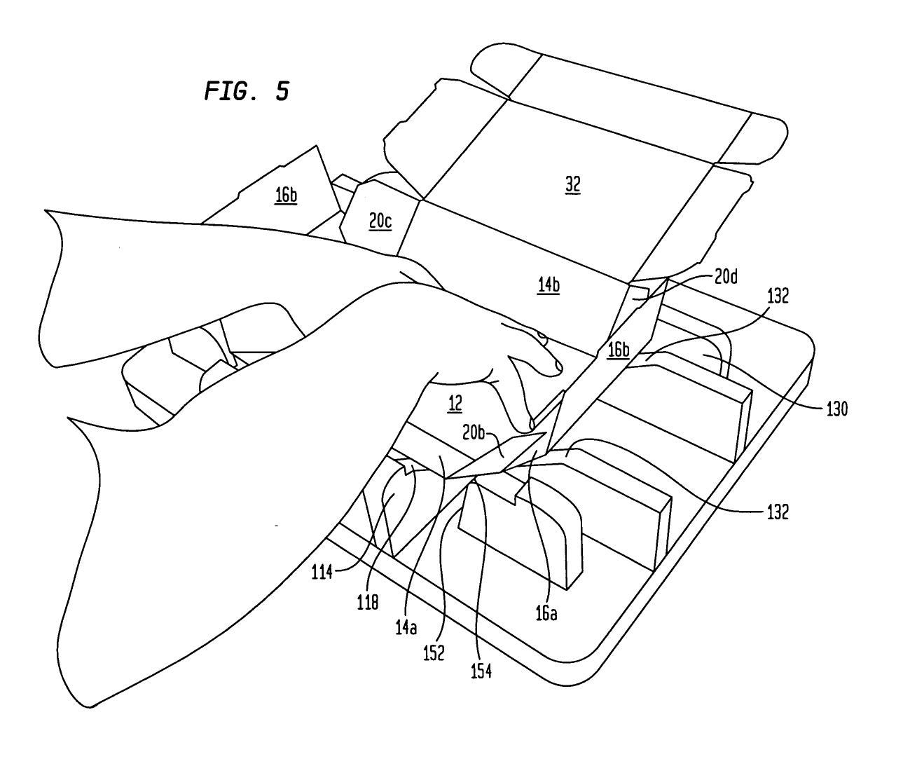

Referring to FIG. 5, the blank 10 may then be pressed downwardly at the panel 12, which causes the corner panels 20a, 20b, 20c, 20d to fold upwardly and inwardly. Simultaneously, the side panels 16a begin to fold and the side panels 16b begin to lift, and also the end panels 14a, 14b to begin to fold upwardly and inwardly. In accordance with an aspect of the invention, the panels 20a, 20b, 20c, 20d are caused to be folded first to a greater extent, from the start of folding of the panels of the blank 10, in relation to the folding of the panels 16a, 16b, because of the positions of the surfaces of the edges 154, 152 and 173, 172 of the respective guides 150 and 170, in relation to the positions of the surfaces of the edges 132 of the guides 130. Consequently, the panels 20a-20d are folded so that the panels 20a-20d at least partially overlie the inwardly facing surfaces of the side panels 16b, as the side panels 16b are folded.

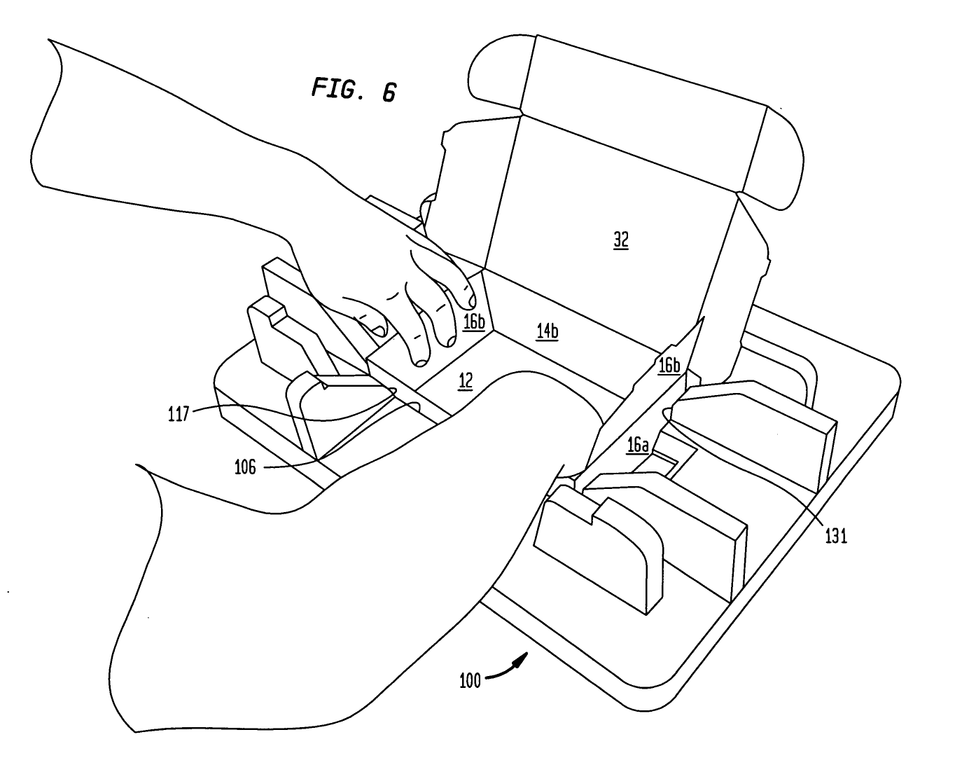

As the blank 10 is pressed further downwardly into the jig 100, the panel 12 enters the aperture 104. Also, the inclined folding surfaces 112, 118 continue to fold and lift the end panels 14a, 14b, and the end panels 14a, 14b are received in the aperture 104 at the corresponding walls 106. Further, the inclined folding surfaces 132 continue to fold and lift the side panels 16a, and the side panels 16a are received in the aperture 104 at the corresponding walls 108. As the panel 12 continues to move downwardly into the aperture 104, the vertical folding surfaces 131 of the guides 130 lift the side panels 16a into vertical positions at right angles to the surface 107, and the vertical folding surfaces 111, 117 lift the end panels 14a, 14b into vertical positions at right angles to the surface 107, as shown in FIG. 6. At this point in the assembly of the box 300, the panels 20a, 20b, 20c, 20d overlie the inwardly facing surfaces of the panels 16a and are at least partially within the aperture 104.

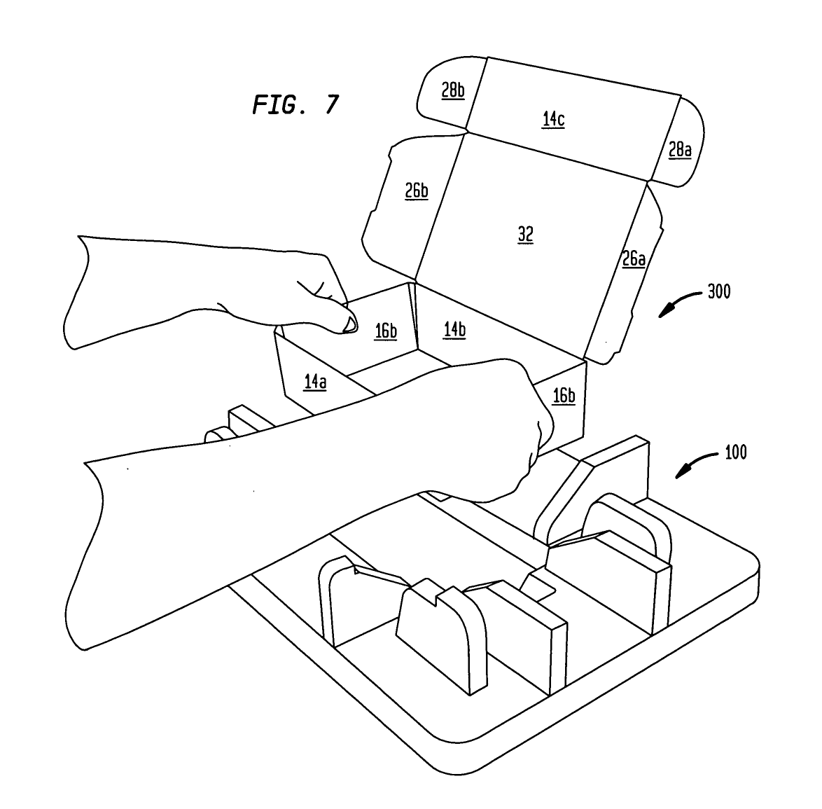

Still referring to FIG. 6, the side panels 16a and the end panels 14a, 14b are engaged within the aperture 104, such that they are held in a vertical position and the blank 10 is a partially folded position. Then, the side panels 16b may be folded by hand inwardly, in the direction of the aperture 104, to provide that the panels 16b are substantially parallel with and overlie the inwardly facing surfaces of the corresponding side panels 16a and the tabs 17 of the panels 16b may be inserted into the respective apertures 19. The partially folded blank 10, which corresponds to a partially assembled box 300, may then be removed manually from the jig 100, as shown in FIG. 7.

Assembly of the box 100 may be completed by initially manually folding the panels 28a, 28b toward inwardly facing surface of the panel 14c so the panels 28a, 28b are perpendicular to inwardly facing surface of the panel 14c. Then, the panel 14c may be manually folded inwardly so that the panel 14c is perpendicular to inwardly facing surface of the panel 32. Then, the panels 26a, 26b may be manually folded toward inwardly facing surface of the panel so that the panels 26a, 26b are perpendicular to the inwardly facing surface of the panel 32 and contact the folded panels 28a, 28b. The panel 32 and the folded panels 14c, 26a, 26b, 28a, 28b may then be inserted into the box 10, such that the panel 14c overlies the inwardly facing surface of the panel 14a and the panels 26a, 26b overlie the inwardly facing surfaces of the respective panels 16b.

Thus, an apparatus in accordance with aspects of the present invention permits manual construction of boxes from blanks, such as the exemplary blank described above, inexpensively, accurately and quickly.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An apparatus for folding a blank into a box, wherein the blank includes a base panel attached to opposing first and second side panels and opposing first and second end panels, first and second corner panels attached respectively to opposing edges of the first end panel, and third and fourth corner panels attached respectively to opposing edges of the second end panel, the apparatus comprising:
a base having opposing first and second sides and opposing first and second ends;
at least one first side panel folding means and at least one second side panel folding means arranged on the first side and the second side of the base, respectively, wherein each of the at least one first and second panels means includes folding surfaces that extend upwardly and outwardly from the base for engaging and folding the first side panel and the second side panel, respectively;
at least a first end panel folding means arranged on the first end of the base and including a folding surface that extends upwardly and outwardly from the base for engaging and folding the first end panel;
at least one second end panel folding means arranged on the second end of the base and including a folding surface that extends upwardly and outwardly from the base for engaging and folding the second end panel, wherein the at least one second end panel folding means includes a first positioning means for positioning the second end panel prior to folding of the blank;
first and second corner panel folding means arranged opposite each other on the first and second sides of the base, respectively, wherein each of the first and second corner panel folding means includes a folding surface that extends upwardly and outwardly from the base for engaging and folding, respectively, the first corner panel and the second corner panel, wherein each of the first and second corner panel folding means includes a second positioning means for positioning, respectively, the first corner panel and the second corner panel prior to folding of the blank;
third and fourth corner panel folding means arranged opposite each other on the first and second sides of the base, wherein each of the third and fourth corner panel folding means includes a folding surface that extends upwardly and outwardly from the base for engaging and folding, respectively, the third corner panel and the fourth corner panel;
wherein the first, second, third and fourth corner panel folding means and the first and second side panel folding means are adapted such that, when the blank is in an unfolded condition on the apparatus with the first and second corner panels positioned by the first positioning means and the third and fourth corner panels positioned by the second positioning means, and when the blank is pressed in the direction of the base, the first, second, third and fourth corner panels are folded upwardly by the folding surfaces of the respective first, second, third and fourth corner panel folding means so that the first and third corner panels overlie inwardly facing surface of the first side panel and the second and fourth corner panels overlie inwardly facing surface of the second side panel as the first and second side panels are folded inwardly by the folding surfaces of the first and second side panel folding means, respectively.

2. The apparatus of claim 1, wherein the base defines an aperture for receiving the base panel and the first and second side panels, the first and second end panels and the first, second, third and fourth corner panels.

3. The apparatus of claim 1, wherein the folding surfaces of the first and second end panel folding means have vertical lower portions substantially perpendicular to the base.

4. The apparatus of claim 1, wherein the folding surfaces of the first and second side panel folding means have vertical lower portions substantially perpendicular to the base.

5. The apparatus of claim 1, wherein the folding surfaces of the first and second side panel folding means, and the first and second end panel folding means have outwardly inclined upper portions.

6. The apparatus of claim 1, wherein the folding surfaces of the first, second, third and fourth corner panel folding means have a steeper incline than the folding surfaces of the first and second side panel folding means and the first and second end panel folding means.

7. The apparatus of claim 1, wherein at least one of the first and second side panel folding means includes two side panel folding means arranged parallel to each other along the corresponding side of said base.

8. The apparatus of claim 1, wherein the at least one first end panel folding means includes two first end panel folding means arranged parallel to each other along the first end of said base.

9. The apparatus of claim 1, wherein the first and second positioning means include a surface substantially orthogonal to the base.

10. The apparatus of claim 1, wherein the first and second positioning means include a surface substantially parallel to the base.

11. The apparatus of claim 1, wherein the base defines an aperture adjacent to each of the first and second side panel folding means.

12. A method for folding a blank into a box, wherein the blank includes a base panel attached to opposing first and second side panels and opposing first and second end panels, first and second corner panels attached respectively to opposing edges of the first end panel, and third and fourth corner panels attached respectively to opposing edges of the second end panel, the method comprising:
positioning the blank horizontally over an apparatus having a plurality of folding surfaces;
pressing the blank downwardly into the apparatus to engage the folding surfaces, such that the first, second, third and fourth corner panels are folded upwardly, and the first and third corner panels are positioned inside the first side panel and the second and fourth corner panels are positioned inside the second side panel as the first and second side panels and the first and second end panels are folded inwardly toward the base.

13. The method of claim 12 further comprising:
folding the first and second side panels, the first and second end panels, and the first, second, third and fourth corner panels into an aperture of the base of the apparatus.

14. An apparatus for folding a blank into a box, wherein the blank includes a base panel attached to opposing first and second side panels and opposing first and second end panels, first and second corner panels attached respectively to opposing edges of the first end panel, and third and fourth corner panels attached respectively to opposing edges of the second end panel, the apparatus comprising:
base;
positioning means extending from the base for positioning the blank over the base in a predetermined position;
side panel folding means disposed on opposite sides of the base and including folding surfaces that extend upwardly and outwardly from the base;
end panel folding means disposed at opposite ends of said base and including folding surfaces that extend upwardly and outwardly from the base;
corner panel folding means disposed on opposite sides of the base and including folding surfaces that have a greater incline than the incline of the folding surfaces of the side panel folding means, such that, when the blank is positioned over the base of the apparatus by the positioning means and pressed in the direction of the base, the first, second, third and fourth corner panels are folded upwardly to a first extent before the side panels are folded to the first extent.

15. The apparatus of claim 14, wherein, when the blank is positioned over the base of the apparatus by the positioning means and pressed in the direction of the base, the first and second side panels are folded inwardly toward the base panel by the side panel folding means with the first, second, third, and fourth corner panels overlying inwardly facing surfaces of the first and second side panels.

16. The apparatus of claim 14, wherein the base defines an aperture for receiving the base panel and the first and second side panels, the first and second end panels and the first, second, third and fourth corner panels.

17. The apparatus of claim 14, wherein the end panel folding means has a vertical lower folding surface substantially perpendicular to the base.

18. The apparatus of claim 14, wherein the side panel folding means has a vertical lower folding surface substantially perpendicular to the base.

19. The apparatus of claim 14, wherein the side panel folding means and the end panel folding means have outwardly inclined upper folding surfaces.

20. The apparatus of claim 14, wherein the positioning means includes surfaces substantially parallel and orthogonal to the base.
